(19) United States
(12) Patent Application Publication
(10) Pub. No.: US 2022/0001688 A1
(43) Pub. Date: Jan. 6, 2022

(54) MULTI-PURPOSE THREE-DIMENSIONAL OBJECT

(71) Applicants: Dong Hwan CHUNG, Busan (KR); Gyeong Deog JUNG, Geochang-gun, Gyeongsangnam-do (KR)

(72) Inventors: Dong Hwan CHUNG, Busan (KR); Gyeong Deog JUNG, Geochang-gun, Gyeongsangnam-do (KR)

(21) Appl. No.: 17/295,118

(22) PCT Filed: Nov. 25, 2019
(86) PCT No.: PCT/KR2019/016298

§ 371 Date: May 19, 2021

(30) Foreign Application Priority Data
Nov. 26, 2018 (KR) 10-2018-0147800

(51) Int. Cl. B44C 3/12; B42D 1/00; G09B 19/10; B44C 5/08

(52) U.S. Cl. CPC B44C 3/12; B44C 5/08; G09B 19/10; B42D 1/007

(57) ABSTRACT

The present invention relates to a multi-purpose three-dimensional object intended to be applied in a three-dimensional form by applying a planar object composed of a pattern portion and a base portion to various uses. That is, the multi-purpose three-dimensional object of the present invention comprises: a plate-shaped pattern portion (2) having a pattern image (21) in which the image is expressed so as to be visually noticed, and a base portion (3) coupled to one side of the pattern portion (2). According to the present invention, by the addition of various functions and design elements to the pattern portion (2), there is an advantage of being used as a three-dimensional interior decoration means or as an educational means for infants.

### TECHNICAL FIELD

The present disclosure relates to a multi-purpose three-dimensional object and, more particularly, an object composed of a pattern part and a base part and intended to be applied in a three-dimensional form by applying the object to various uses.

### BACKGROUND OF THE INVENTION

Among the existing printed objects, for example, a business card, scratch paper, a leaflet, a book, a note insert, etc. commonly has a construction in which text is printed on a simple planar polygon (chiefly rectangular) shape. Such a construction is not different from a printed object of a competitor. Accordingly, it is necessary for a shape to be different from a competitive product by constructing a shape having a visual three-dimensional effect so that the shape has more peculiarity by adding a design element to the shape.

Among techniques for solving this problem, as published in Korean Utility Model No. 20-0296320, an assembly memo stand is configured to maintain a plane state at normal times. When being used, the assembly memo stand can be used for various decoration and memo stand uses due to a change from the plane state to a three-dimensional state. However, the assembly memo stand is very limitedly used because it is inevitably used as a memo stand in a space part.

Among other conventional technologies, Korean Patent No. 10-1254441 published in 2013 relates to a pop-up device which is formed as a three-dimensional stage stretched and fixed in an upright state, enabling three-dimensional play, such as a theater play stage or a pop-up card, and which can be easily kept due to a minimized thickness in a folded state, but does not generate damage or breakage although the pop-up device is stretched 90 degrees or more. The pop-up device has a problem in that it is not greatly attractive to consumers due to a low difference with the existing pop-up book because the pop-up device has a common pop-up book construction which does not have a design element when being folded, but has a pop-up card folded therein to stand upright when being stretched.

### OBJECT OF THE INVENTION

The present disclosure has invented a new technique in order to solve the problems of the conventional technology, and an object of the present disclosure is to construct an object composed of a pattern part and a base part, but provide a multi-purpose three-dimensional object which may be applied to various uses by adding various functions and design elements to the pattern part.

### SUMMARY OF THE INVENTION

As detailed means for solving the object of the present disclosure, the present disclosure, a multi-purpose three-dimensional object is configured to include a plate-shaped pattern part having a pattern image on which an image is represented in a way to be visually noticed and a base part configured in one side of the pattern part.

a pattern coupling part and a base coupling part formed in one side of the pattern part and one side of the base part, respectively, may be further included so that the pattern part is inserted and attached and detached to and from the base part or,

an extension assembly pattern part formed to be combined by a pattern assembly part formed to be assembled with one side of the pattern part in a female and male manner may be further included or,

a double-sided folding part formed in the middle of the pattern part so that both sides of a pattern image surface are viewed by folding the pattern part in a mountain form so that the pattern part stands upright may be further included or,

a pattern standing piece attached and formed in one surface and both surfaces of the pattern part in order to increase a three-dimensional feeling on a side or a plane may be further included or,

an extension image surface formed in the base part so that an image is connected from the pattern image surface may be further included or,

one electronic device means of one of a lighting device or a sound playback device or a watch formed in the pattern part or the base part and power supply means connected to the electronic device means through an electric wire in the base part may be further included or,

an envelope in which an envelope slot into which a reception base part formed in the base part is inserted is opened at the top of the envelope so that the pattern part is exposed may be further included or,

a storage part may be further included in which a storage space part into which multiple reception base parts formed in the base part are stacked and inserted so that the pattern part is exposed or,

a bookbinding part formed in one side of the pattern part or the base part so that the base part is combined with a book may be further included or,

an extension bookbinding pattern part which has a bookbinding part formed on one side thereof, which is isolated from the pattern part at a given distance and in which an image is represented to have continuity with an image of the pattern image may be further included or,

multiple extension pieces elongated and formed toward one side or both sides of the base part to form an edge whose side is not opened upon assembly may be further included or,

an adhesion part attached to the packing target and formed in the base part so that the pattern part stands upright may be further included or,

a support extension piece configured to have the bottom of the base part closed upon assembly by using a folding line as a boundary at the bottom may be further included or,

a bent piece composed of an iron piece connected and attached between the pattern part and the base part so that the pattern part stands upright may be further included or,

a support base part integrated with the base part and composed of an iron piece combined with the pattern part so that the pattern part stands upright may be further included or,

the pattern part further includes a symmetry folding part having the top and bottom formed in a symmetrical form so that the pattern part is folded in a V shape, and a horizontal incised part formed in the symmetry folding part so that the bent piece is combined with the pattern part or,

the pattern part may further include a rotatory model part combined with a rotatory connection hole in a way to correspond to the rotatory connection hole and configured to be movable in a fixed model part fixed to the base part.

According to the detailed means for solving the aforementioned object, the multi-purpose three-dimensional object can be easily applied with a three-dimensional feeling by changing a basic form for various uses and various shapes by adding a design element.

A decoration effect for an interior is high due to a maximized aesthetic factor that attracts attention.

A new play culture can be created because the multi-purpose three-dimensional object can be used by men and women of all ages.

If the multi-purpose three-dimensional object is applied to education materials, a sense of accomplishment can be increased and brain development can be helped after learning because curiosity and fun are felt and imagination and creativity are stimulated.

There is an advantage in that a manufacturing cost is low and productivity is high due to a simple structure.

The multi-purpose three-dimensional object is a technique capable of representing a planar figure, a photo, a scene, etc. in a three-dimensional miniature form, and it is expected to develop into one field of a formative art as an object which can stand upright and is a creative idea that presents a new paradigm of the existing pop-up book.

Furthermore, the multi-purpose three-dimensional object may be applied to various industry fields, such as LED lighting tools, by being grafting onto the digital technology.

### BRIEF DESCRIPTION OF DRAWINGS

FIG. 1 is a front view illustrating an example of the present disclosure.

FIG. 2 is a three-dimensional view illustrating that an example of the present disclosure has been bent and stood up.

FIG. 3 is a three-dimensional view illustrating the separation of a pattern part and a base part in the present disclosure.

FIG. 4 is a three-dimensional view illustrating the coupling of the pattern part and the base part in the present disclosure.

FIG. 5 is a three-dimensional view illustrating an example in which an extension assembly pattern part has been applied to the present disclosure.

FIG. 6 is an exploded view illustrating an example of a double-sided folding part according to the present disclosure.

FIG. 7 is an assembly view illustrating an example of the double-sided folding part according to the present disclosure.

FIG. 8 is a separated view illustrating an example in which a pattern standing piece has been applied to the present disclosure.

FIG. 9 is a combination view illustrating an example in which the pattern standing piece has been applied to the present disclosure.

FIG. 10 is a three-dimensional view illustrating an example in which electronic means has been applied to the present disclosure.

FIG. 11 is a three-dimensional view illustrating an example in which the present disclosure has been applied to an envelope.

FIG. 12 is a three-dimensional view illustrating an example in which an inspection window has been applied to the envelope of the present disclosure.

FIG. 13 is a three-dimensional view illustrating an example in which the envelope of the present disclosure has been multi-applied.

FIG. 14 is a three-dimensional view illustrating an example in which the envelope of the present disclosure is made to stand upright.

FIG. 15 is a three-dimensional view illustrating an example in which the present disclosure has been applied to a storage part.

FIG. 16 is a three-dimensional view illustrating an example in which the present disclosure has been stacked to have a thickness in the storage part.

FIG. 17 is a three-dimensional view illustrating an example in which the present disclosure is applied to a book.

FIG. 18 is a three-dimensional view illustrating another example in which the present disclosure is applied to a book.

FIG. 19 is a three-dimensional view illustrating an example of an extension bookbinding pattern part of the present disclosure.

FIG. 20 is a three-dimensional view illustrating an example in which the envelope of the present disclosure is applied to a book.

FIG. 21 is a three-dimensional view illustrating an example in which the storage part of the present disclosure is applied to a book.

FIG. 22 is a three-dimensional view illustrating another example in which the envelope or storage part of the present disclosure has been applied.

FIG. 23 is a three-dimensional view illustrating an example in which the present disclosure has been applied to a box.

FIG. 24 is an exploded view illustrating an example in which an extension piece has been applied to the present disclosure.

FIG. 25 is an assembly view illustrating an example in which an extension piece has been applied to the present disclosure.

FIG. 26 is a three-dimensional view illustrating an example in which the present disclosure has been attached to a packing target.

FIG. 27 is an exemplary diagram illustrating an example in which a bent piece has been applied to the present disclosure.

FIG. 28 is a three-dimensional view illustrating another example in which the bent piece has been applied to the present disclosure.

FIG. 29 is a three-dimensional view illustrating an example in which a rotatory part has been applied to the present disclosure.

### DETAILED DESCRIPTION OF THE INVENTION

The present disclosure is intended to provide a multi-purpose three-dimensional object, and is more specifically described below along with the drawings.

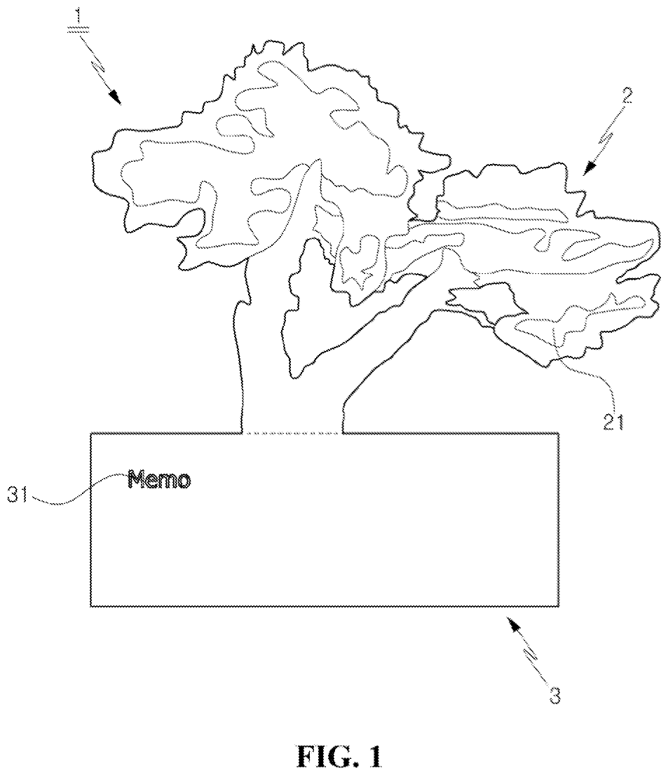

In the multi-purpose three-dimensional object (1) of the present disclosure, as illustrated in FIG. 1, a plate-shaped pattern part (2) is formed by printing a pattern image (21) including various images, such as an animal, a plant, people, a thing, a building, a letter, a symbol, or a character, or so that the pattern image has a feeling of engraving and embossing. In this case, the pattern part may be processed to have its edge cut suitably for the image.

A base part (3) is combined with one side of the pattern part (2). In FIG. 1, the base part (3) is formed at the bottom of the pattern part (2), but the base part (3) may be combined with the side or top of the pattern part, if necessary. For example, if a monkey holding onto a bough is represented in the pattern part (2), a tree may be represented using the base part (3) formed at the top of the pattern part (2).

Two or more pattern parts (2) may be combined with one base part (3).

A base printed surface (31) may be formed on one surface and both surfaces of the base part (3), if necessary. The multi-purpose three-dimensional object (1) may be variously applied and used, such as that stripes may be printed on the base printed surface (31) if the multi-purpose three-dimensional object (1) is used as scratch paper, a promotional phrase may be printed on the base printed surface (31) if the multi-purpose three-dimensional object (1) is used as a leaflet, personal data may be printed on the base printed surface (31) if the multi-purpose three-dimensional object (1) is used as a business card, and explanatory comments may be printed on the base printed surface (31) if the multi-purpose three-dimensional object (1) is used as educational materials.

Accordingly, the multi-purpose three-dimensional object (1) is characterized in that it includes the plate-shaped pattern part (2) having the pattern image (21) and the base part (3) combined with one side of the pattern part (2).

The multi-purpose three-dimensional object (1) may be fabricated using one or more of materials, including paper, synthetic resins, metal, and wood.

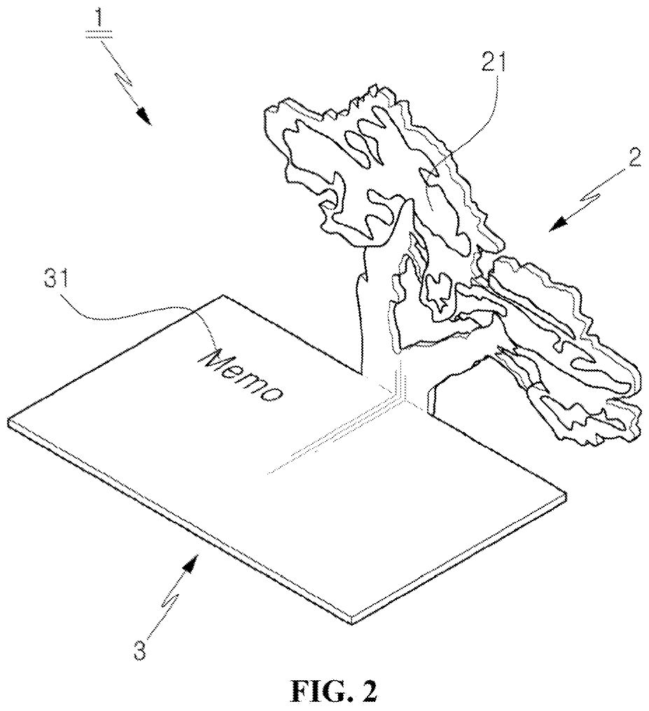

As in FIG. 2, in the multi-purpose three-dimensional object (1), some of the pattern part (2) or the base part (3) may be bent so that the pattern part (2) easily stands upright.

The multi-purpose three-dimensional object (1) may be solely used, but may be variously applied as in multiple embodiments.

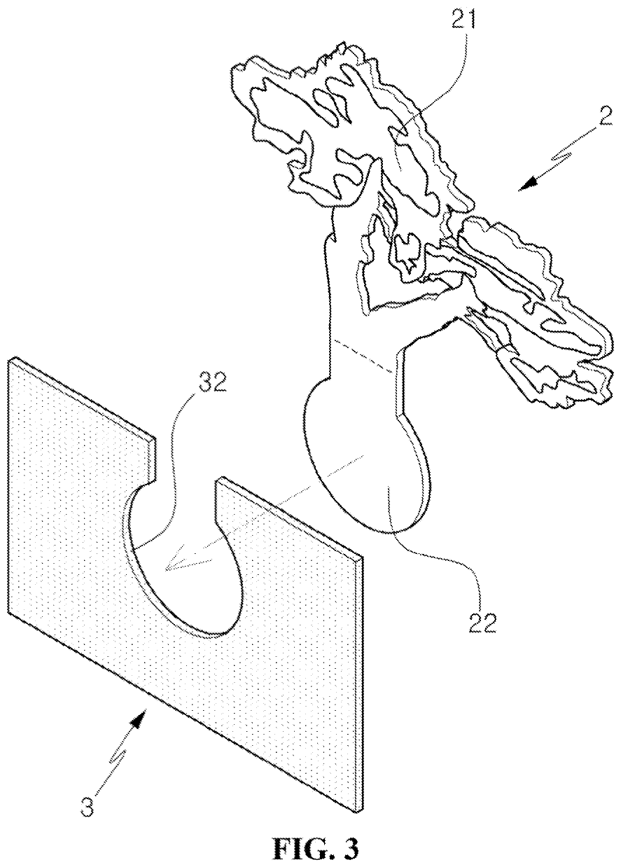

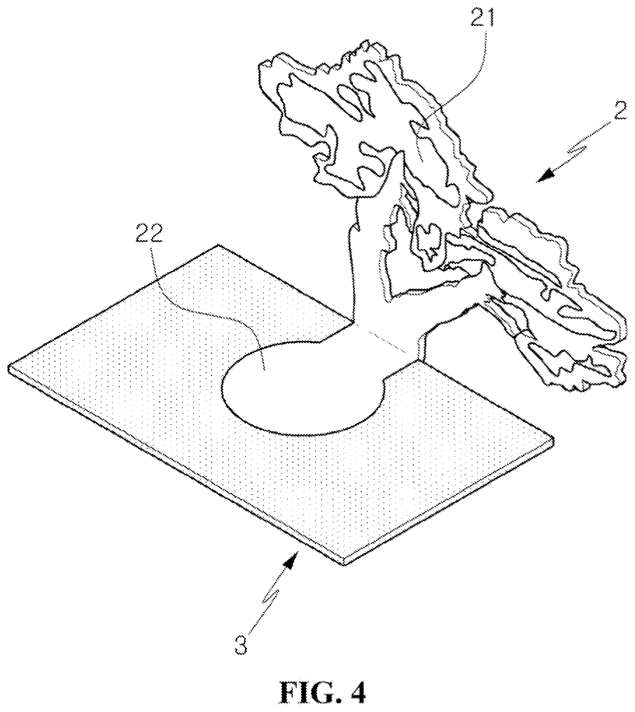

As in FIGS. 3 and 4, the base part (3) and the pattern part (2) may be attached to or detached from each other by forming a pattern coupling part (22) on one side of the pattern part (2) and forming a base coupling part (32) in a way to correspond to the pattern coupling part (22). In this case, the pattern part (2) for a replacement or the base part (3) for a replacement may be prepared by standardizing shapes of the pattern coupling part (22) and the base coupling part (32).

The pattern part (2) may be changed by changing the type of flower, for example, by variously substituting the pattern part (2) that embodies a flower in the base part (3) that embodies a flower pod, thus always giving a new feeling.

Furthermore, as in FIG. 4, the pattern part (2) may be made to stand upright by bending some of the pattern part (2).

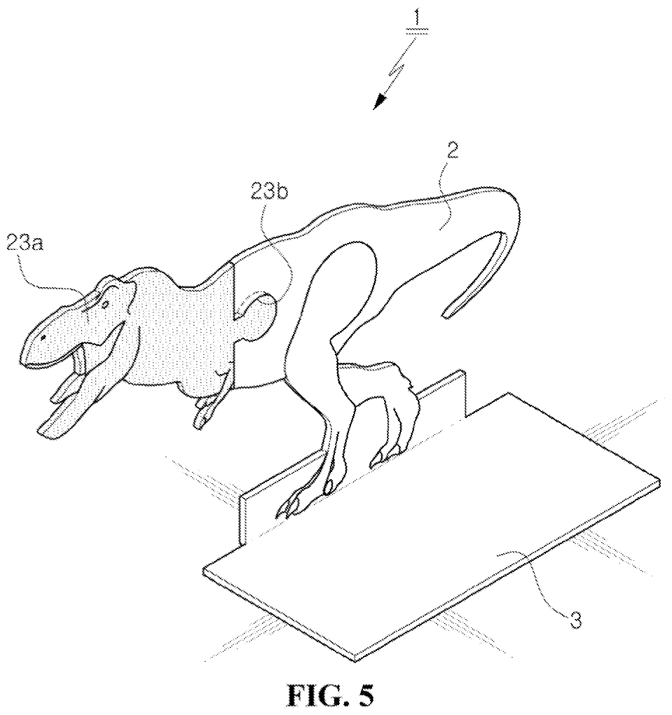

As in FIG. 5, an extension assembly pattern part (22) which may be combined with or separated from a pattern assembly part (23b) by using various assembly means, such as assembling one side of the pattern part (2) in a female and male manner in an uneven form or assembling incision parts by using fitting coupling, a magnet, etc., may be additionally configured. In this case, by separating the extension assembly pattern part (22), the multi-purpose three-dimensional object (1) can be easily kept and engineering interests may be caused when the multi-purpose three-dimensional object (1) is used as a toy for children, thereby enhancing creativity.

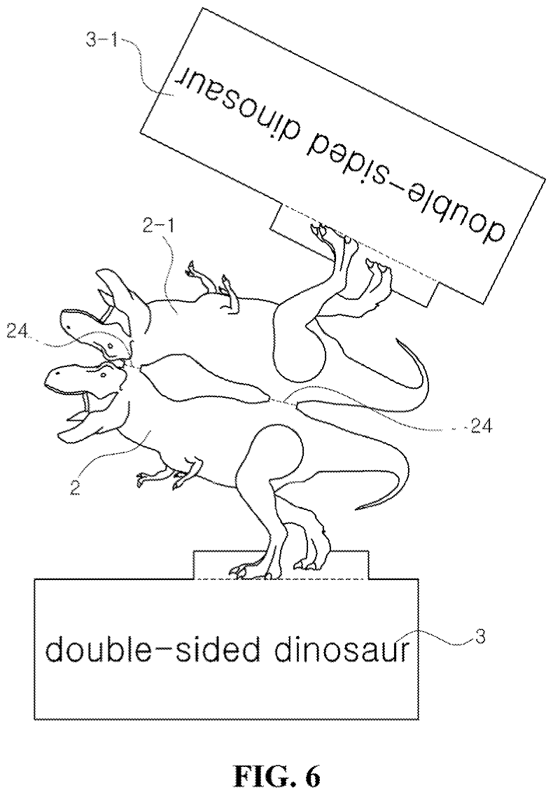

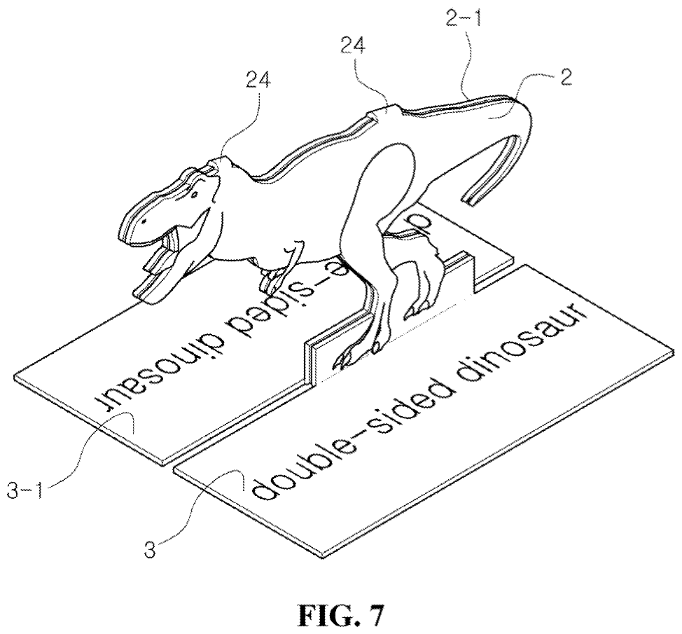

As in FIGS. 6 and 7, a double-sided folding part (24) may be formed on one side of the pattern part (2). A rear pattern part (2-1) symmetrical to the pattern part (2) with respect to the double-sided folding part (24) may be formed. A rear base (3-1) symmetrical to the base part (3) may be formed on one side of the rear pattern part (2-1).

The pattern part (2) and the rear pattern part (2-1) may be folded to stand upright in a mountain form with respect to the double-sided folding part (24). Accordingly, both surfaces of the pattern part can be viewed. If the pattern part (2) and the rear pattern part (2-1) are folded to stand upright in a mountain form, the base part (3) is disposed at the bottom and used as a support.

The pattern part (2) or the base part (3) may be partially bent to stably stand upright. Alternatively, if the pattern part (2) or the base part (3) maintains a given angle when they are folded with respect to the double-sided folding part (24), the multi-purpose three-dimensional object (1) may be made to stand upright even without separately bending the pattern part (2) and the base part (3).

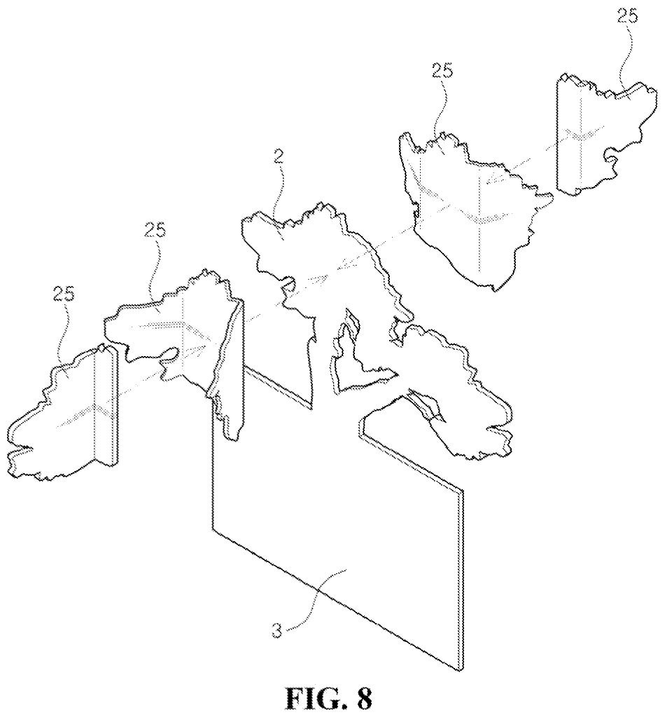

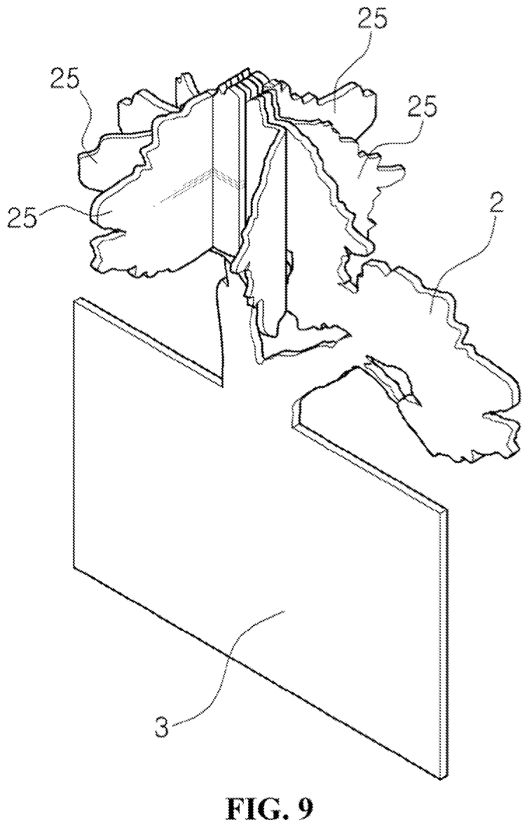

As in FIGS. 8 and 9, pattern standing pieces (25) may be additionally formed and attached to one surface and both surfaces of the pattern part (2) in order to prevent a three-dimensional feeling of the pattern part (2) from being decreased when viewed from a plane and to increase a decoration and play effect.

The pattern standing pieces (25) may also be additionally combined together.

If the pattern standing pieces (25) are attached in a form that stands upright front and rear, a three-dimensional the object having a further three-dimensional feeling when the pattern part (2) is viewed on a plane or from the side can be obtained.

The pattern part (2) may be used as a background frame by applying the pattern standing pieces (25). The pattern standing piece (25) may be formed to have the same size as the pattern part (2), but may be cut to be small split and used as a kind of puzzle play tool. In this case, means which may be easily attached to or detached from the pattern part (2), such as a magnet or an adhesion sticker, may be additionally configured in the pattern standing pieces (25).

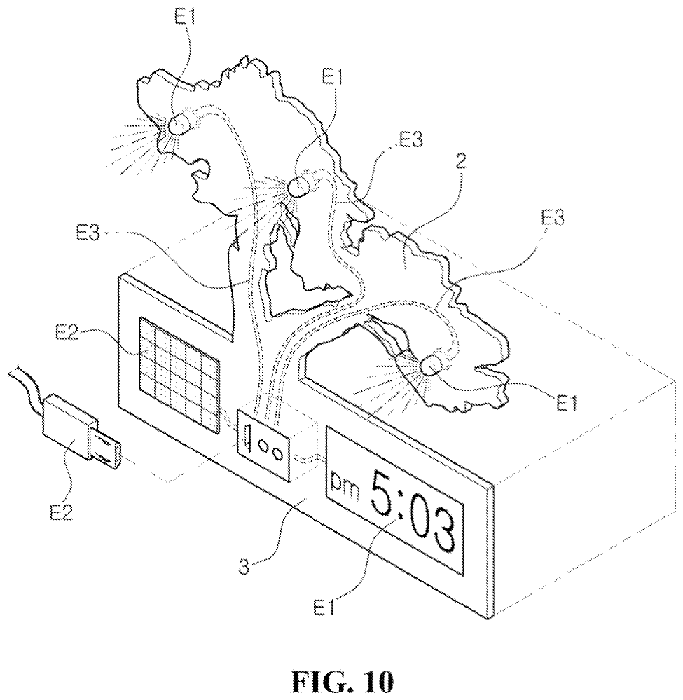

As in FIG. 10, various electronic devices may be combined with the pattern part (2) or the base part (3). For example, a lighting device, such as an LED, may be attached to the pattern part (2) or the base part (3) in order to brighten the surroundings or draw attention by using sparkling lights. Alternatively, a sound playback device, such as a speaker, may be attached to the pattern part (2) or the base part (3) in order to draw attention through a sound. Alternatively, an analog watch or a digital watch may be attached to the pattern part (2) or the base part (3) in order for time to be easily checked. In order to drive an electronic device (E1), such as the lighting device, the sound playback device or the watch, power supply means (E2) is provided, and the electronic device (E1) and the power supply means (E2) are connected by an electric wire (E3). The power supply means (E2) may use one of various methods, such as supply power through a solar cell plate, an embedded battery or an external USB cable.

Additionally, a proximity sensor, etc. may be mounted and operate only when a person is present nearby.

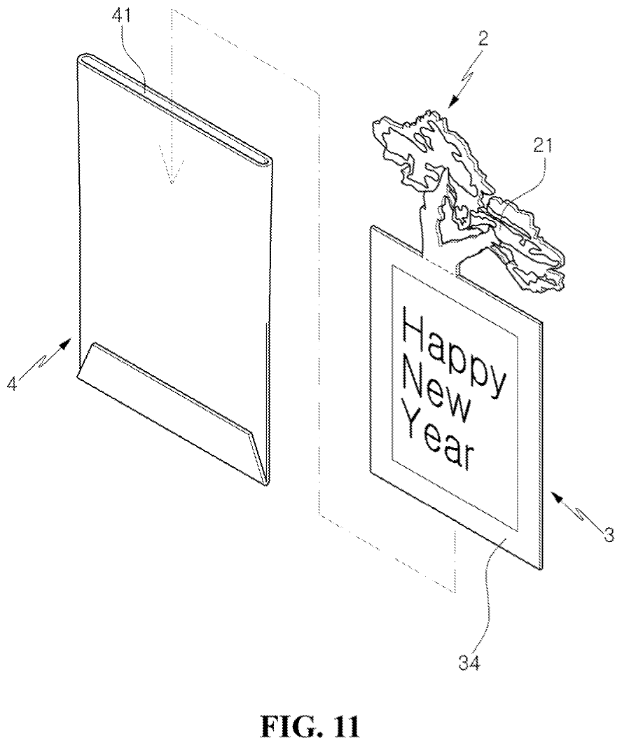

As in FIG. 11, when being used as letter paper, etc., the multi-purpose three-dimensional object (1) may be combined with a dedicated envelope (4). In this case, it is characterized in that the pattern part (2) is exposed and a reception base part (34) formed in the base part (3) is inserted into an envelope slot (41). When the base part (3) is inserted into the envelope, a person who receives the envelope has curiosity and anticipation because only the pattern part (2) is viewed. Furthermore, there is an advantage in that the multi-purpose three-dimensional object (1) can be easily separated from the envelope (4) by using the pattern part (2) as a handle.

The envelope (4) may have various forms without being limited to a rectangular shape, and the size thereof may also be variously applied.

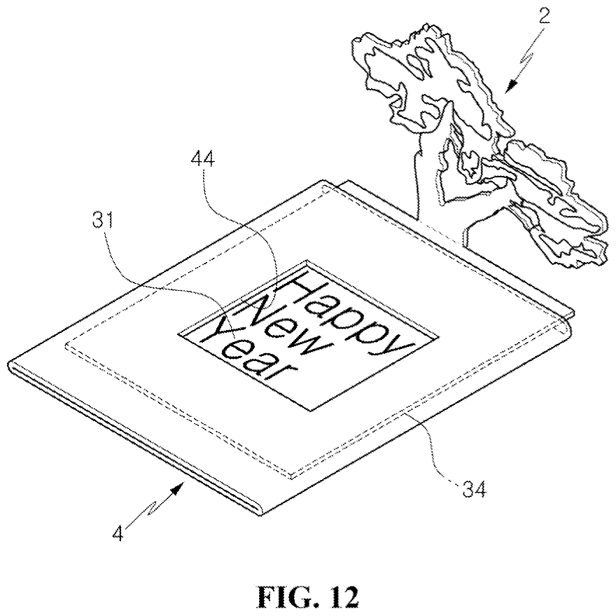

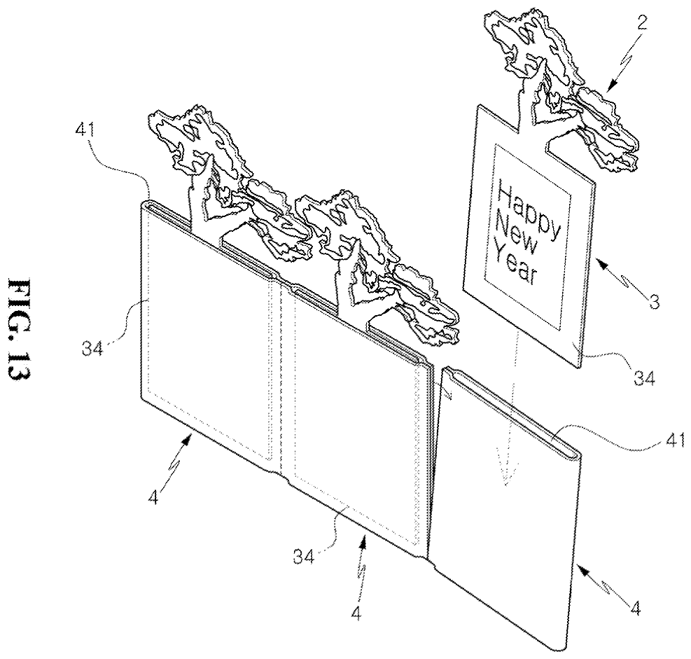

As in FIG. 12, an envelope inspection window (44) may be formed on one side of the envelope (4) so that contents can be checked even without taking out the multi-purpose three-dimensional object (1) from the envelope. The envelope inspection window (44) may simply have an incised shape. A transparent film may be attached to the inside of the envelope inspection window (44) for water-proofing, etc.

Furthermore, the pattern part (2) of the multi-purpose three-dimensional object (1) inserted into the envelope may be randomly bent to stand upright. The multi-purpose three-dimensional object (1) may be separated from the envelope so that the pattern part (2) is made to independently stand upright and used.

As in FIG. 13, multiple envelopes (4) may be connected and formed so that various three-dimensional objects (1) may be inserted into the respective envelope slots (41). The envelopes (4) may be configured to be taken off apiece depending on a material of the envelope (4).

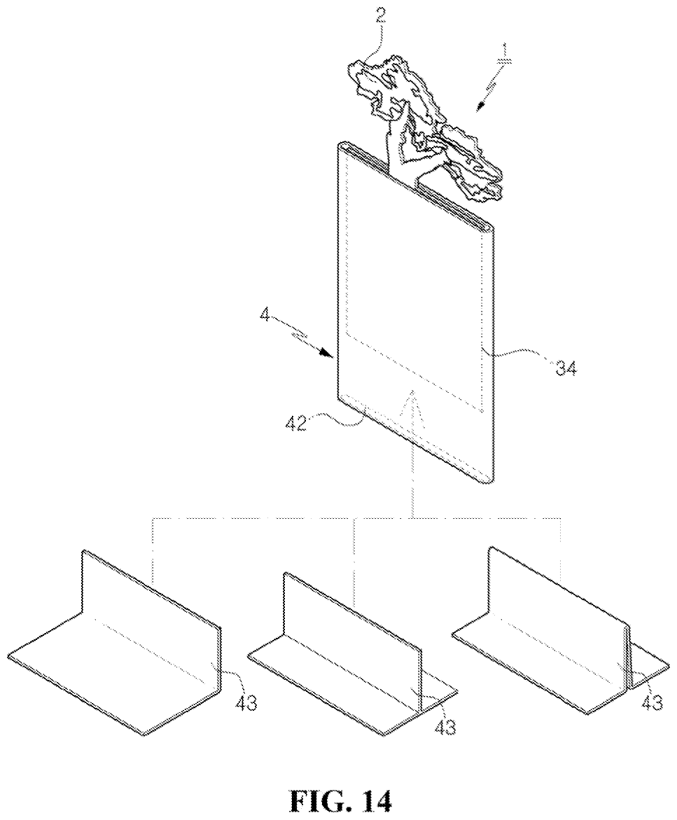

As in FIG. 14, an envelope coupling slot (42) may be opened at the bottom of the envelope (4), and an envelope support (43) may be combined with the envelope coupling slot (42) in a way to stand upright. The envelope support (43) may have a support surface formed thereon, and may be formed to have a coupling part orthogonal to the support surface.

The envelope (4) that stands upright as described above has an effect in that it can be easily grasped.

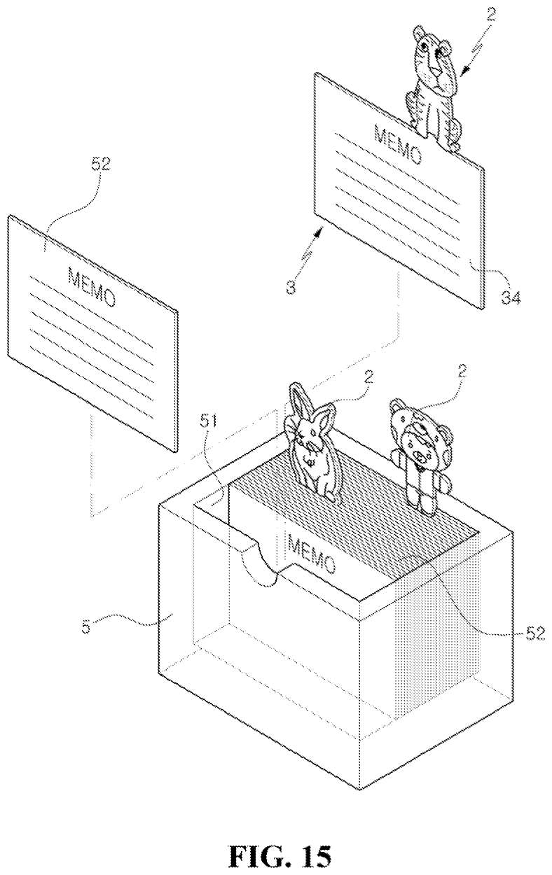

As in FIG. 15, a storage part (5) having a storage space part (51) in which a reception base part (34) formed in the base part (3) is received may be further provided so that multiple multi-purpose three-dimensional objects (1) can be stacked. The storage part (5) which may be used as a memo stand, a business card stand, etc. may also be used as an interior accessory due to the pattern part (2) exposed to have a three-dimensional feeling.

If an air freshener component is contained in the multi-purpose three-dimensional object (1), a delicate scent is generated indoors. The type of scent can be simply changed by only replacing the multi-purpose three-dimensional object (1) containing a different type of an air freshener, if necessary.

Only multiple multi-purpose three-dimensional objects (1) may be stacked in the storage part (5) or inserts (52) having the same size as the base part (3) may be mixed and kept without the pattern part (2).

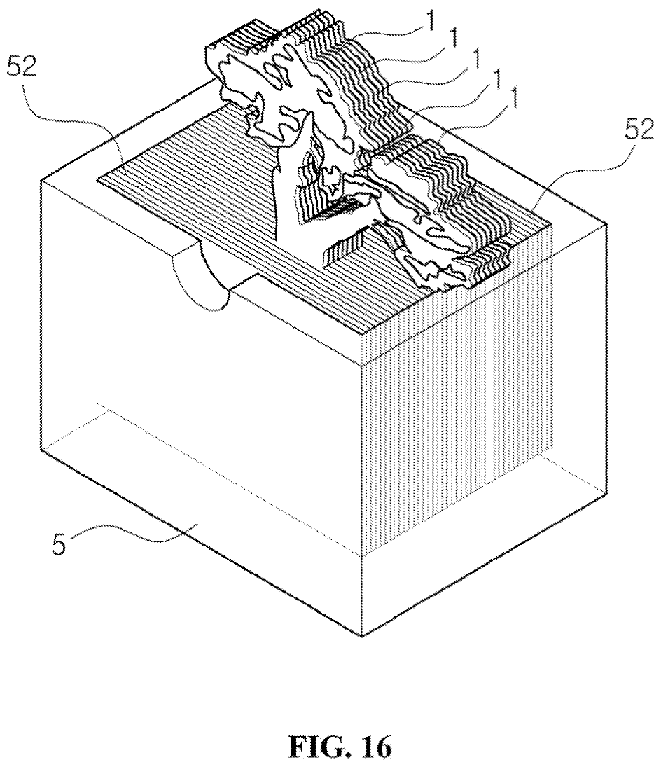

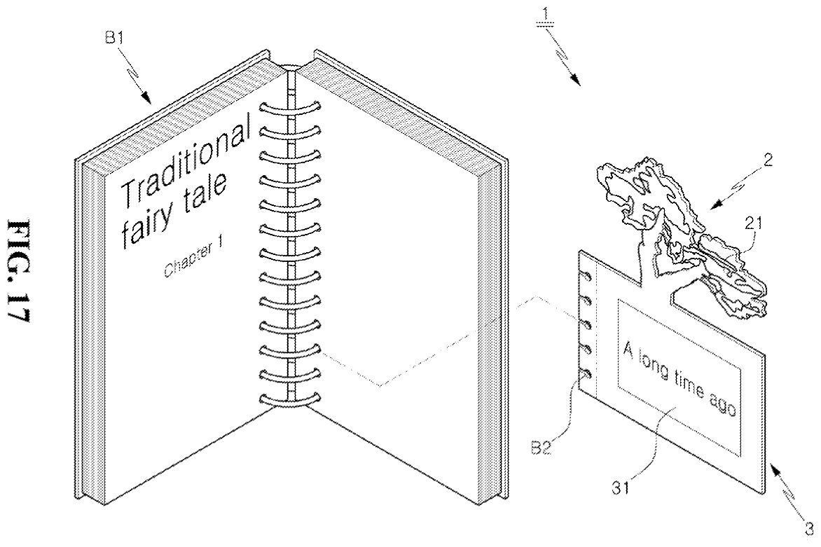

As in FIG. 16, the pattern parts (2) may be overlapped and stacked to have a front and rear thickness in order to have a further three-dimensional representation. The pattern parts (2) may be overlapped as homogeneous patterns having the same size or overlapped as heterogeneous patterns having different sizes in order to further increase a three-dimensional feeling by using perspective and optical illusion effects.

As in FIG. 17, a bookbinding part (B2) may be formed on one side of the base part (3) so that the base part (3) can be combined with a book (B1) of the multi-purpose three-dimensional object (1) on the inside or outside. In this case, the book (B1) comprehensively represents thin notes, a book fabricated by bonding, a note bonded using a spring, etc.

In the case of a spring note, through holes may be formed in the bookbinding part at given intervals so that the spring note can be previously combined upon fabrication of spring binding, or through grooves for spring coupling may be formed as in FIG. 2 or may also be applied as coupling parts bonded upon binding of the book (B1).

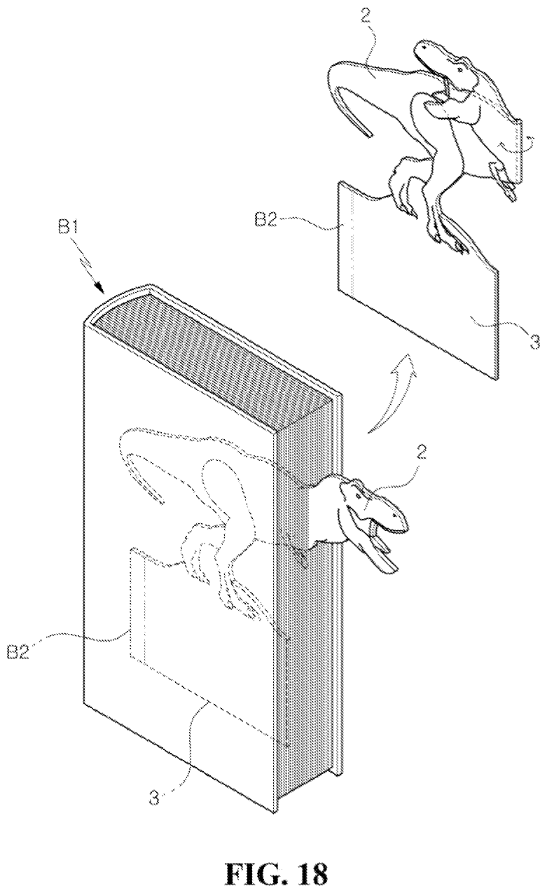

As in FIG. 18, when the multi-purpose three-dimensional object (1) is bound to the book (B1), a part of the pattern part (2) may be formed to be longer than the width or height of the book (B1) so that the pattern part (2) protrudes between sheets of the book (B1) and is used as a bookmark or may also be used as an insert of the book.

When being formed to be longer than the width of the book (B1), the pattern part (2) may be configured in a folding type, if necessary, so that the pattern part (2) is inserted smaller than the width of the book (B1) or the pattern parts (2) may be configured in a separated form so that they are inserted and attached or detached together.

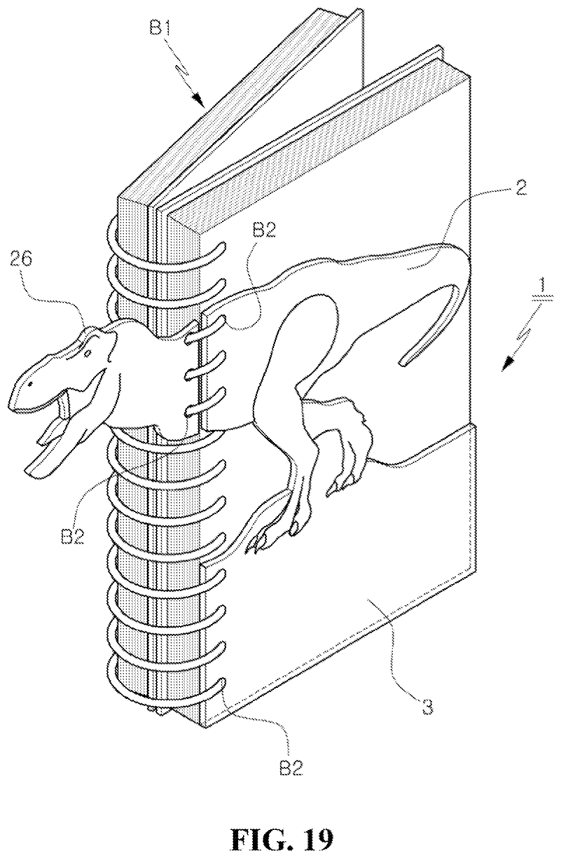

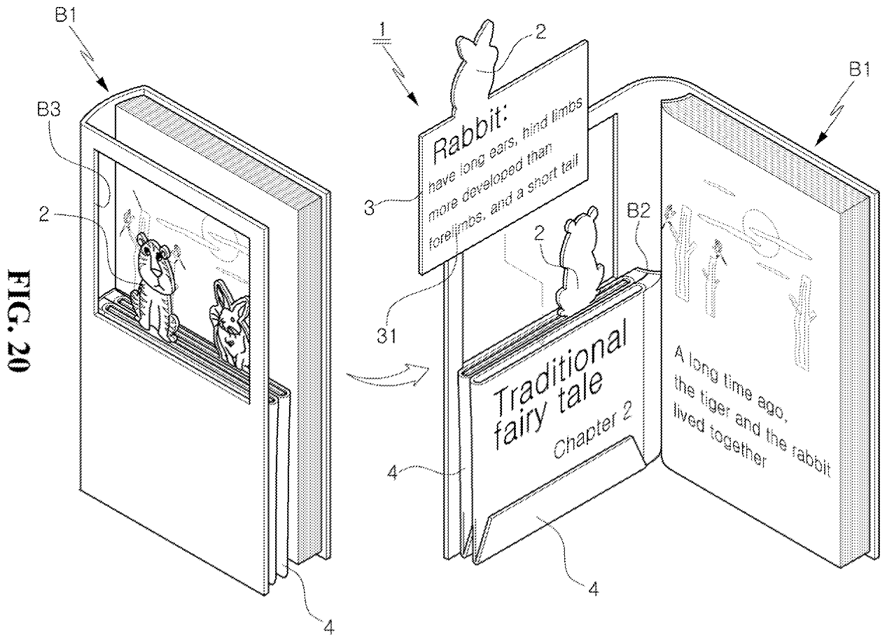

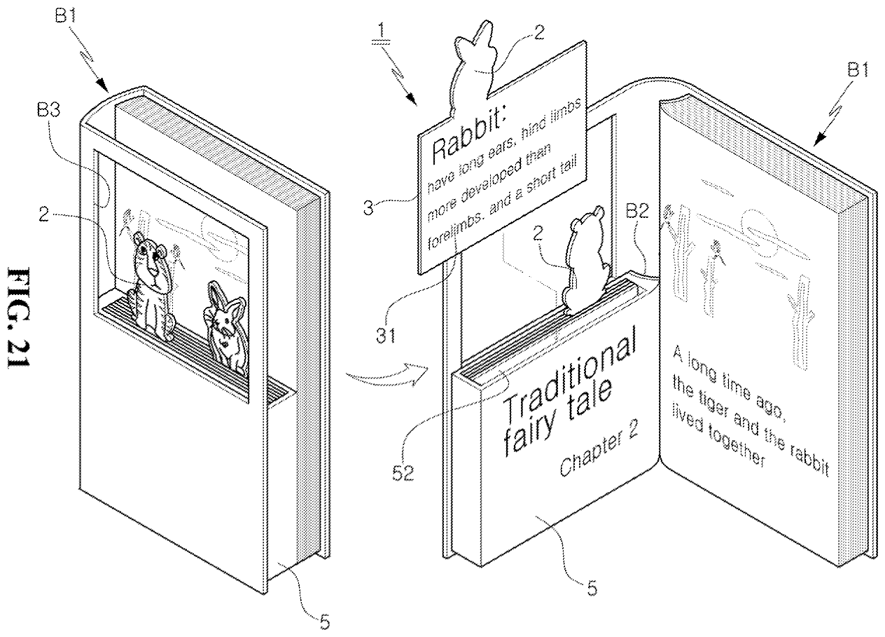

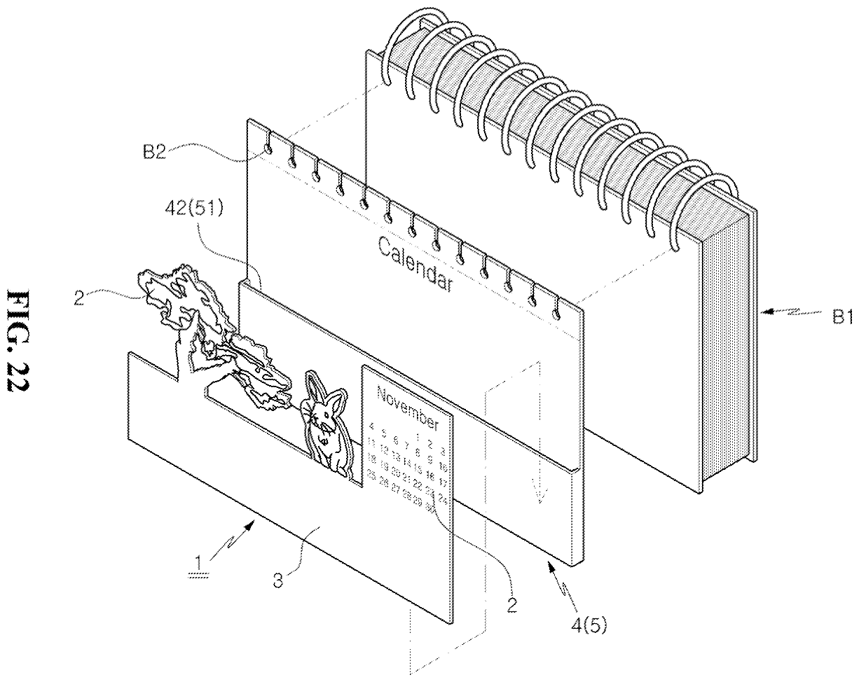

As in FIG. 19, the bookbinding part (B2) is not formed only in one side of the base part (3), but may also be formed in one side of the pattern part (2) so that the pattern part (2) is combined with the book.

Furthermore, if a pattern image (21) to be represented is greater than the width or height of a book, the pattern image is spaced apart from the pattern part (2) at a given distance, but an extension bookbinding pattern part (26) having the bookbinding part (B2) on one side thereof may be further configured. An image represented in the extension bookbinding pattern part is viewed as an image consecutive in the pattern image (21) of the pattern part (2). Accordingly, a target represented as the image provides a three-dimensional feeling along with a feeling as if the target exits from the book, thereby further increasing an interest to a person who views the image.

If the extension bookbinding pattern part (26) is formed, there is an advantage in that the durability of the pattern part (2) is not reduced because it is not necessary to fold or spread the pattern part 2 protruding to the outside of the book due to a large size.

As in FIGS. 20 to 16, multiple envelopes (4) or one storage part (5) may be inserted and combined with the book (B1) by forming a bookbinding part (B2) on one side of the envelope (4) or the storage part (5) capable of being combined with the multi-purpose three-dimensional object (1), that is, the example illustrated in FIG. 11 or 10.

If the multi-purpose three-dimensional object (1) is constructed as described above, the multi-purpose three-dimensional object (1) inserted into the envelope (4) or the storage part (5) provides a three-dimensional feeling when the book (B1) is spread. Accordingly, a reader may have a sense of realism due to the stimulation of imagination. If necessary, the multi-purpose three-dimensional object (1) may be pulled out and provides a reader with information written in the base printed surface (31). The multi-purpose three-dimensional object (1) may be separated from the envelope (4) or the storage part (5) and independently used.

Additionally, if an opening part (B3) is formed by cutting the front of the book (B1), a reader may have aesthetic sensibility and a three-dimensional feeling due to the pattern part (2) disposed in a three-dimensional way although the book is not spread unlike in a common pop-up book. Accordingly, an effect in that anticipation and curiosity for the book are increased may be expected.

As in FIG. 22, a bookbinding part (B2) may be formed in one side that faces the bookbinding part (B2) so that the envelope (4) or the storage part (5) is opened in order to make different a binding direction. In such a case, as illustrated in the drawing, a calendar may be produced so that the multi-purpose three-dimensional object (1) is inserted into or taken out from the envelope (4) or the storage part (5) every month.

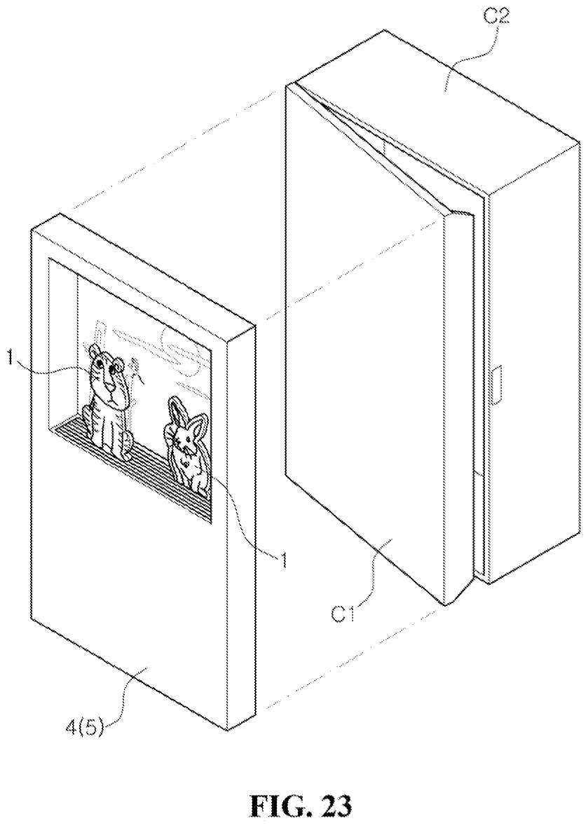

As in FIG. 23, the envelope (4) or the storage part (5) may be configured to be attached to the cover (C1) of a box (C2).

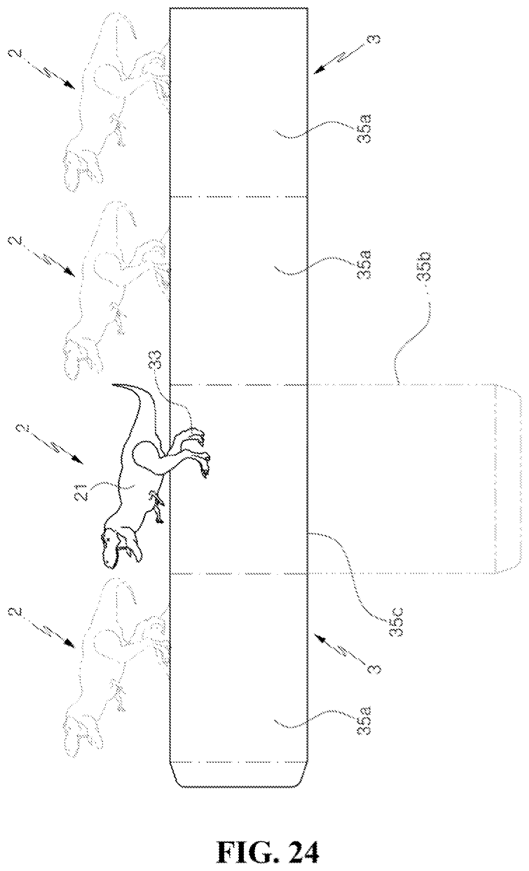

Referring to FIGS. 24 to 20, in the multi-purpose three-dimensional object (1), an extension piece (35a) may be repeatedly formed toward one side of the base part (3) so that the extension pieces (35a) are assembled to form an edge whose side is not opened. In this case, an additional folding line may be placed so that the extension pieces (35a) are assembled in a polygon edge form or may be assembled in a circular edge form without being folded. Such a construction is useful as an interior accessory because the multi-purpose three-dimensional object (1) can made to stand upright in a three-dimensional feeling form.

Alternatively, the extension piece (35a) may surround the book and may be used as a book paper band, a book cover, etc.

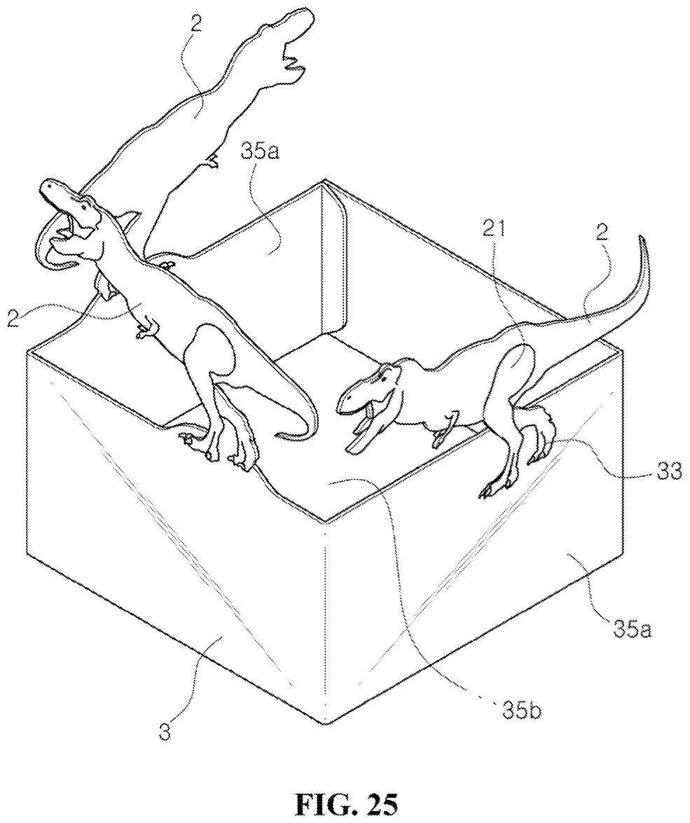

As in FIG. 25, if necessary, an extension image (33) may be formed in the base part (3) so that the pattern image (21) formed in the pattern part (2) is represented as a continuous image even in the base part (3).

In the construction to which the extension piece (35a) has been added, a support extension piece (35b) having a folding line (35c) as a boundary may be additionally configured at the bottom of the multi-purpose three-dimensional object (1). Accordingly, upon assembly, the extension piece (35a) may form a box form without having the bottom opened so that a specific thing can be kept in the box.

If the multi-purpose three-dimensional object (1) is constructed as described above, the multi-purpose three-dimensional object (1) may be used as a storage box.

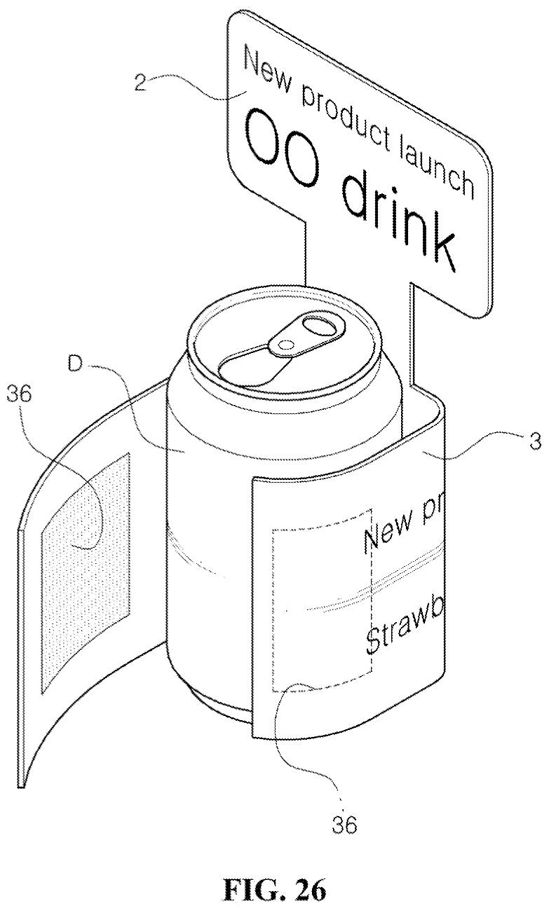

As in FIG. 26, an adhesion pan (36) may be formed on one side of the base part (3) so that the base part (3) is attached to a packing target (D) and the pattern part (2) is made to stand upright. The adhesion part (36) may also be formed in the extension piece (35a) without being limited to the base part (3).

In this case, the multi-purpose three-dimensional object (1) may also be used for decorations for the packing target. A description of the packing target (D) may be written in the pattern part (2) or the base part (3).

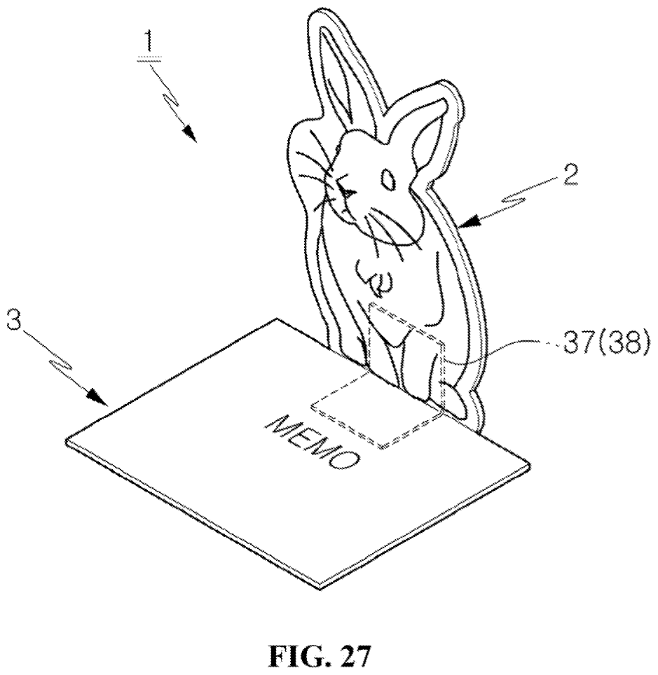

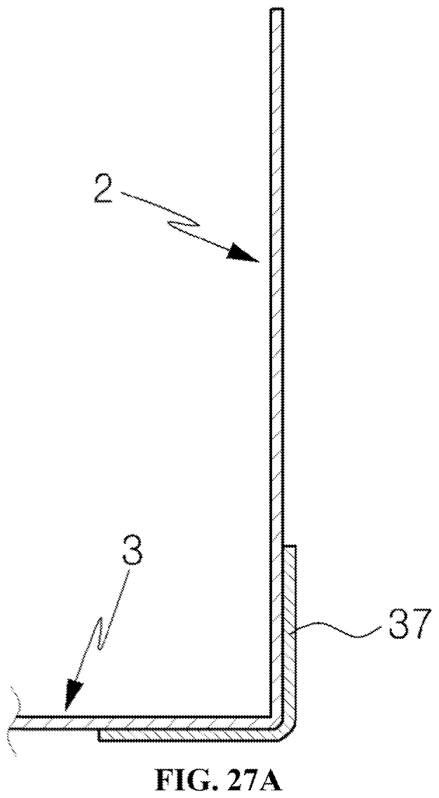

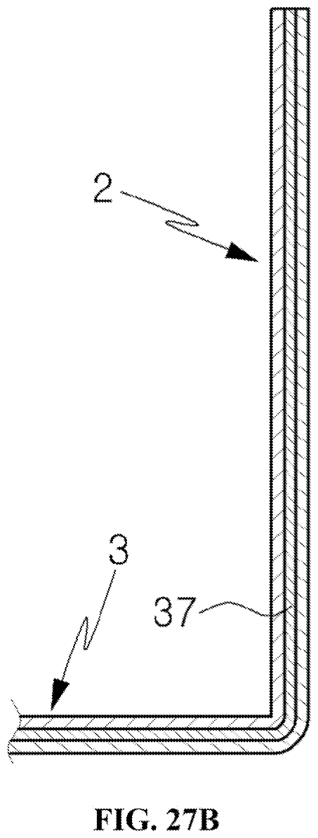

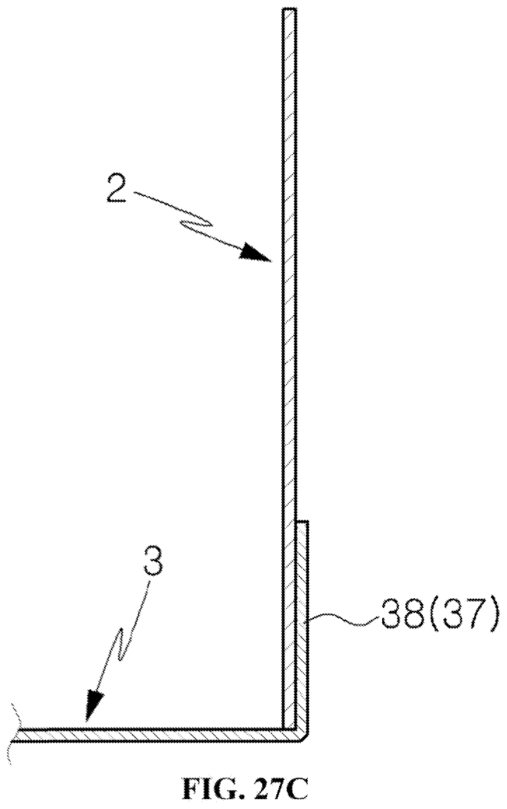

Referring to FIG. 27, in the multi-purpose three-dimensional object (t), a bent piece (37) may be combined with the pattern part (2) so that the pattern part (2) can be made to solely stand upright.

A material, such as metal, is suitable for the bent piece (37).

As in FIG. 27(a), a bent piece (37) may be added in a way to extend to both sides of the pattern part (2) and the base part (3), so the bent piece (37) may be bent to make the pattern part (2) stand upright.

As in FIG. 27(b), the bent piece (37) may be inserted between the pattern part (2) and the base part (3) in a sandwich form, and may be then bent so that the pattern part (2) is made to stand upright.

As in FIG. 27(c), the base part (3) may be integrated with the bent piece (37) and configured as the support base part (38) so that the support base part (38) is bent to make the pattern part stand upright.

If the pattern part (2) is formed to stand upright autonomously, it may also be used as an interior decoration foam, a name tag, a toy, etc.

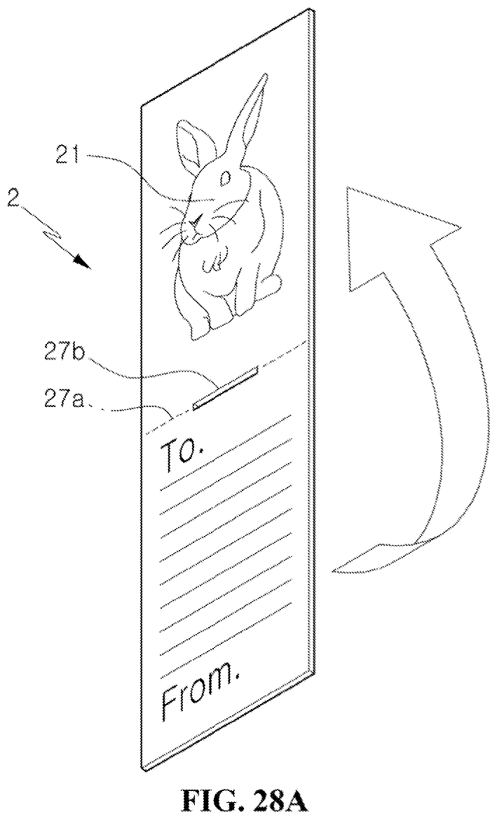

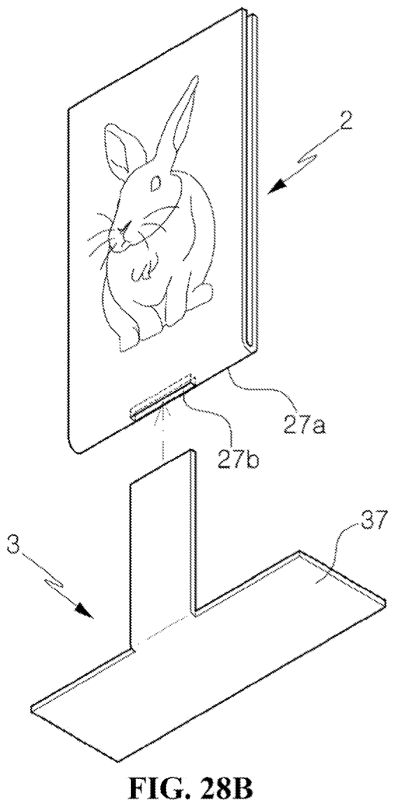

As in FIG. 28, the pattern part (2) may be configured to have a form in which the top and bottom of the pattern part (2) are symmetrical to each other. The pattern part (2) may be folded in a V form with respect to a symmetry folding part (27a) formed to have a horizontal incised part (27b). In this case, the incision part (27b) is exposed to the bottom, and a bent piece (37) is fitted into the incision part (27b) so that the pattern part (2) folded in the V form can stand upright. For example, an image, such as an animal, a plant, or a building, may be displayed on the pattern image (21) at the front, and a space where writing is possible may be drawn in the pattern image (21) at the back, so the multi-purpose three-dimensional object (0) may be used as a three-dimensional picture, a letter, a picture postcard or an invitation.

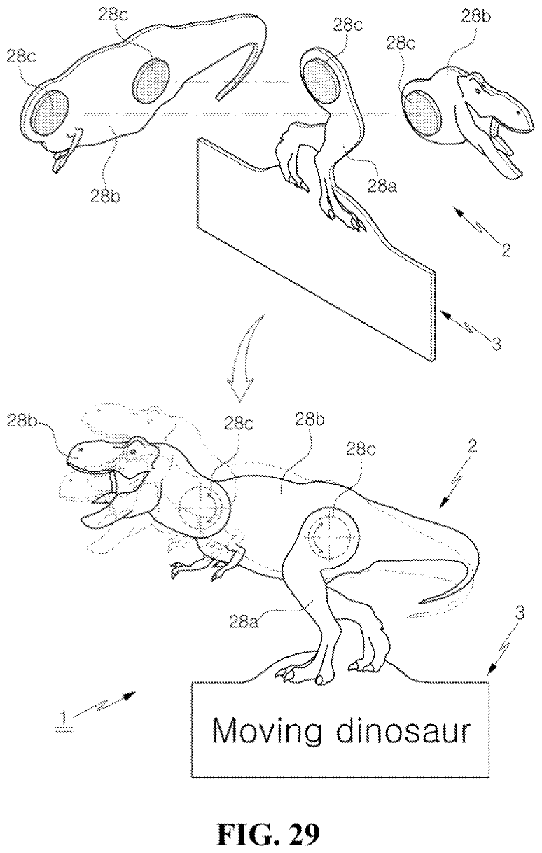

As in FIG. 29, a rotatory connection part (26c) fabricated using a neodymium magnet, a rubber magnet, a snap fastener, facing hinges, etc. may be coupled to one side of the pattern part (2). A rotatory model part (26b) coupled to another corresponding rotatory connection part (26c) facing the rotatory connection part (26c) may be provided. If the multi-purpose three-dimensional object (1) is constructed as described above, the rotatory model part (26b) can be easily rotated or fixed at a given angle by using the rotatory connection part (26c) as a rotating axis. Such a construction can increase a three-dimensional feeling because it is useful to represent a motion of an animal, etc.

As described above, according to various embodiments, aesthetic sensibility can be increased and consumers' attraction can be easily drawn because the multi-purpose three-dimensional object (1) is well noticeable to a person who watches the multi-purpose three-dimensional object 1 by applying the multi-purpose three-dimensional object 1 to various fields in a three-dimensional feeling manner.

As described above, although the preferred embodiments of the present disclosure have been described in the detailed description of the present disclosure, the present disclosure may be variously modified without departing from the technical spirit of the present disclosure. Accordingly, the scope of protection of the present disclosure should not be limited to the embodiments, but the scope of protection of even techniques of the claims to be described later and equivalent technical means from the techniques should be recognized.

The present disclosure has a wide industrial applicability because the present disclosure can be used as three-dimensional interior decoration means or educational means for infants having a three-dimensional feeling by providing a very simple construction composed of the pattern part and the base part and adding various functions and design elements to the pattern part (2).

1. A multi-purpose three-dimensional object, comprising:
a plate-shaped pattern part (2) having a pattern image (21) on which an image is represented in a way to be visually noticed; and
a base part (3) configured in one side of the pattern part (2).

2. The multi-purpose three-dimensional object of claim 1, further comprising a pattern coupling part (22) and a base coupling part (32) formed to be protruded from or inserted into the pattern part (2) or the base part (3) and formed to be mutually combined in a corresponding way.

3. The multi-purpose three-dimensional object of claim 1, further comprising an extension assembly pattern part (23a) formed to be detachable by a pattern assembly part (23b) formed to be assembled into one side of the pattern part (2).

4. The multi-purpose three-dimensional object of claim 1, further comprising:
a double-sided folding part (24) formed in one side of the pattern part (2);
a rear pattern part (2-1) formed to be symmetrical to the pattern part (2) with respect to the double-sided folding part (24); and
a rear base part (3-1) formed in one side of the rear pattern part (2-1) in a way to be symmetrical to the base part (3),
wherein the pattern part (2) and the rear pattern part (2-1) are folded in a mountain form to stand upright with respect to the double-sided folding part (24).

5. The multi-purpose three-dimensional object of claim 1, further comprising pattern standing pieces (25) attached and formed in one surface and both surfaces of the pattern part (2) in order to increase a three-dimensional feeling on a side or on a plane.

6. The multi-purpose three-dimensional object of claim 1, further comprising an extension image (33) formed in the base part (3) so that an image is connected from the pattern image (21).

7. The multi-purpose three-dimensional object of claim 1, further comprising:
one electronic device E1 of one of a lighting device or a sound playback device or a watch formed in the pattern part (2) or the base part (3); and
power supply means (E2) connected to the electronic device (E1) through an electric wire (E3) in the base part (3).

8. The multi-purpose three-dimensional object of claim 1, further comprising an envelope (4) in which an envelope slot (41) having a reception base part (34), formed in the base part (3), inserted therein is opened at a top of the envelope (4) so that the pattern part (2) is exposed.

9. The multi-purpose three-dimensional object of claim 8, further comprising an envelope support (43) combined with an envelope coupling slot (42) formed at a bottom of the envelope (4) so that the envelope (4) stands upright.

10. The multi-purpose three-dimensional object of claim 1, further comprising a storage part (5) in which a storage space part (51) having multiple reception base parts (34), formed in the base part (3), stacked and inserted therein is formed so that the pattern part (2) is exposed.

11. The multi-purpose three-dimensional object of claim 10, wherein when multiple pattern parts (2) are received, the multiple pattern parts are received in a way that homogeneous patterns or heterogeneous patterns are overlapped so that all the overlapped pattern parts (2) form one pattern.

12. The multi-purpose three-dimensional object of claim 1, further comprising a bookbinding part (B2) formed in one side of the pattern part (2) or the base part (3) so that the base part (3) is combined with a book (B1).

13. The multi-purpose three-dimensional object of claim 1, further comprising an extension bookbinding pattern part (26) which has a bookbinding part (B2) formed on one side thereof, which is isolated from the pattern part (2) at a given distance and in which an image is represented to have continuity with an image of the pattern image (21).

14. The multi-purpose three-dimensional object of claim 8, further comprising a bookbinding part (B2) formed in one side of the envelope (4) or the storage part (5) so that the envelope (4) or the storage part (5) is combined with a book (B1).

15. The multi-purpose three-dimensional object of claim 8, wherein the envelope (4) or the storage part (5) is configured to be attached to a cover (C1) of a box (C2).

16. The multi-purpose three-dimensional object of claim 1, further comprising multiple extension pieces (35a) elongated and formed toward one side or both sides of the base part (3) to form an edge whose side is not opened upon assembly.

17. The multi-purpose three-dimensional object of claim 1, further comprising an adhesion part (36) formed on one surface of the base part (3) to attach the base part (3) to a packing target (D).

18. (canceled)

19. (canceled)

20. The multi-purpose three-dimensional object of claim 1, further comprising a support base part (38) integrated with the base part (3) and composed of an iron piece combined with the pattern part (2) so that the pattern part (2) stands upright.

21. The multi-purpose three-dimensional object of claim 20, further comprising;
a folding type pattern part (27) formed in a form in which a top and bottom of the pattern part (2) are symmetrical to each other;
a symmetry folding part (27a) formed as a reference line so that the folding type pattern part (27) is folded in a V shape; and
a horizontal incised part (27b) formed in the symmetry folding part (27a) so that the bent piece (37) is inserted and combined with the pattern part (2).

22. The multi-purpose three-dimensional object of claim 1,
wherein the pattern part (2) further comprises a rotatory model part (28b) combined with a rotatory connection hole (28c) in a way to correspond to the rotatory connection hole (28c) and configured to be movable in a fixed model part (28a) fixed to the base part (3).
